(19) United States
(12) Patent Application Publication
(10) Pub. No.: US 2006/0090968 A1
(43) Pub. Date: May 4, 2006

(54) Brake assembly with brake pad position and wear sensor

(75) Inventors: Martin Taylor, Cwmbran (GB); Jeffrey Thomas, New Inn (GB); Royston Morris, Newport (GB); Lester Clarke, Burgess Hill (GB); Mark Norman, Bridgend (GB)

Correspondence Address: CARLSON, GASKEY & OLDS, P.C., 400 WEST MAPLE ROAD, SUITE 350, BIRMINGHAM, MI, 48009, US

(73) Assignee: Meritor Heavy Vehicle Braking Systems (UK) Ltd.

(21) Appl. No.: 10/978,737

(22) Filed: Nov. 1, 2004

(51) Int. Cl. F16D 66/00

(52) U.S. Cl. 188/1.11 L

(57) ABSTRACT

A brake assembly includes a sensor mounted to a brake component, and which is in communication with a transceiver. The sensor provides position information of the brake component, which is combined with known mechanical relationships between various brake components, to determine a wear state of a brake pad and a clearance between the brake pad and a rotor. The clearance is then adjusted based on signals from the sensor and the known mechanical relationship between the various brake components to maintain the clearance within desired limits.

### BACKGROUND OF THE INVENTION

This invention generally relates to a brake assembly, and more specifically to a brake assembly including a sensor for monitoring brake pad wear and clearance between a brake pad and a rotating brake member.

Conventional brake assemblies include an adjustable member known in the art as a tappet assembly driven by a rotatable operating shaft. The operating shaft includes eccentrically positioned pockets that transmit rotational forces through rollers to the tappet assembly. Typically, the tappet assembly includes a threaded nut and screw that are adjusted to change length and thereby a clearance between a brake pad and a rotating brake member such as a rotor. An electric motor is employed to drive either the screw or nut to change the overall length of the tappet assembly and adjust the clearance between the brake pad and the rotor.

The clearance between the brake pad and rotor is monitored by measuring displacement of specific brake components, such as the operating shaft, with sensors such as linear or rotary encoders, which are driven by a brake component during operation. Signals from the linear or rotary encoder are stored in a memory for use by a controller during adjustment of the clearance. Displacement of the brake components combined with known mechanical relationships between brake components is then used to determine the clearance between the brake pad and the rotor. A brake pad wear condition is monitored by measuring the position of specific brake components such as a brake housing, pad back plates, tappet screws or nuts or any other mechanically connected components.

Disadvantageously, modifications to specific brake components, such as the operating shaft, may be required to provide mounting and drive features for the encoders. The mounting and drive features within the brake assembly may wear with use, possibly causing inaccurate position information. Encoders provide limited accuracy and dependability, due to the high temperatures and vibrations to which the brake assemblies are subjected. The encoders also consume much of the limited space within the brake assembly. Further, the encoder may require modification of many brake components to incorporate specific mounting and drive features.

Accordingly, it is desirable to design an accurate, adaptable, compact and reliable method and device for determining a wear condition and clearance between a brake pad and a rotor.

### SUMMARY OF INVENTION

The present invention is a brake assembly including a sensor mounted to a movable brake component. The sensor is in communication with a transceiver that provides information indicative of a current position of a brake component.

The brake assembly of this invention includes a caliper housing mounted over a rotor, which is mounted to an axle of a vehicle. The brake assembly is actuated by movement of an actuator that drives an operating shaft for rotation about an axis. The operating shaft includes eccentrically positioned pockets engaged to rollers. Rotation of the operating shaft about the axis drives the rollers linearly against a pair of tappet assemblies. The tappet assemblies in turn move brake pads into contact with the rotor.

A controller receives information concerning the current position of the tappet assemblies and operating shaft from a transceiver. The transceiver communicates with a sensor positioned to relay information indicative of a brake component position. The position of the brake component is combined with known mechanical relationships between various brake components to determine a clearance between the brake pads and the rotor. Adjustment is then made to the length of the tappet assemblies to maintain the clearance within desired limits. Additionally, the length of the tappet assemblies is measured by a further transceiver and sensor. This measurement is compared to a start or datum length of the tappet assemblies to determine the amount of wear of the brake pads.

Accordingly, the present invention provides an accurate and adaptable method and device for determining clearance between a brake pad and rotor, and the wear conditions of the brake pads.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of a brake assembly;

FIG. 2 is a schematic view of a sensor mounted for rotation with an idler gear;

FIG. 3 is a schematic view of another brake assembly of this invention;

FIG. 4 is a schematic view of sensors mounted for movement with a tappet assembly and an operating shaft; and

FIG. 5 is a schematic view of another brake assembly of this invention.

### DETAILED DESCRIPTION OF THE PREFERRED EMBODIMENT

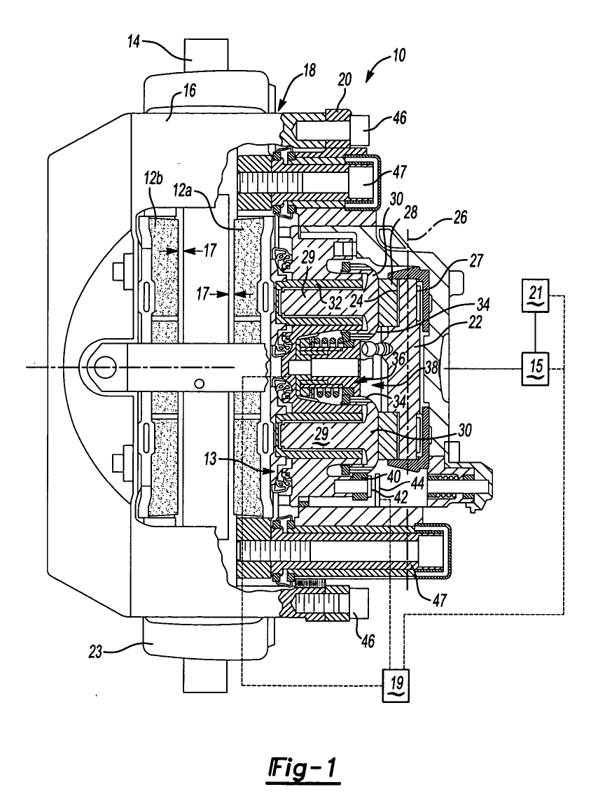

Referring to FIG. 1, a brake assembly 10 includes a caliper housing 18 including an outer caliper housing 16 bolted to an inner housing 20 by bolts 46. The caliper housing 18 is mounted over a rotor 14 mounted to an axle of a vehicle. The caliper housing 18 slides relative to a fixed caliper pad carrier 23. The caliper housing 18 slides along guide sleeves 47 relative to the fixed caliper pad carrier 23.

The brake assembly 10 is actuated by movement of an actuator such as an air cylinder and pushrod schematically shown at 15. The actuator 15 may be of any known configuration including, for example, a pneumatically or hydraulically actuated piston or an electric motor. The actuator 15 rotationally drives an operating shaft 22 about an axis 26. A load sensor 21 is provided for detecting a load on the actuator 15.

The operating shaft 22 is supported on bearings 27 mounted within the inner housing 20 and includes pockets 24 engaged with rollers 28 that are positioned eccentric to axis 26. Rotation of the operating shaft 22 perpendicular to the axis 26 transmits a force to the rollers 28. The pockets 24 of the operating shaft 22 provide a magnification of the force exerted by the actuator 15 on the operating shaft 22. The rollers 28 translate movement of the operating shaft 22 into linear movement against tappet assemblies 29. The tappet assemblies 29 in turn drive against a rear surface 13 of a first brake pad 12A. The first brake pad 12A traverses a clearance 17 to engage the rotor 14. Contact between the rotor 14 and the first brake pad 12A pulls the caliper housing 18 and a second brake pad 12B on an opposite side of the rotor 14 into clamping engagement. Clamping engagement of the rotor 14 between the first and second brake pads 12A, 12B produces the desired braking force to control rotation of the rotor 14.

The brake pads 12A, 12B wear and therefore a length of the tappet assemblies 29 is adjustable to maintain the clearance 17 within desired parameters. Each tappet assembly 29 includes a tappet screw 30 threaded within a stationary tappet nut 32. Rotation of the tappet screw 30 changes the overall length of the tappet assembly 29 to adjust the clearance 17 between the rotor 14 and the brake pads 12A, 12B.

An electric motor 38 is disposed within the brake assembly 10 and drives a gear assembly 36. The gear assembly 36 is engaged to tappet gears 34 disposed on the tappet screws 30. The electric motor 38 rotates the tappet screws 30 to change the overall length of the tappet assemblies 29. A controller 19 controls actuation of the electric motor 38 to adjust the length of the tappet assemblies 29 and maintain the clearance 17 within desired limits.

The controller 19 receives information concerning the current length of the tappet assemblies 29 from a transceiver 44. The transceiver 44 communicates with a sensor 42, which in one example embodiment is positioned on an idler gear 40. The sensor 42 is preferably an inductive resonance device that receives and transmits signals in response to a prompt signal from the transceiver 44. The inductive resonance device does not require an external, or internal power source or any other wired connection with a transceiver, power source or controller. Power for the sensor 42 is provided by prompt signals emitted from the transceiver 44. The transceiver 44 and sensor 42 are easily packaged within the brake assembly 10. Moreover, the transceiver 44 and sensor 42 may be arranged in numerous configurations, as will be appreciated from the examples described below. The transceiver 44 coupled with information from the load sensor 21 provides for the determination of the clearance 17 and of brake pad wear.

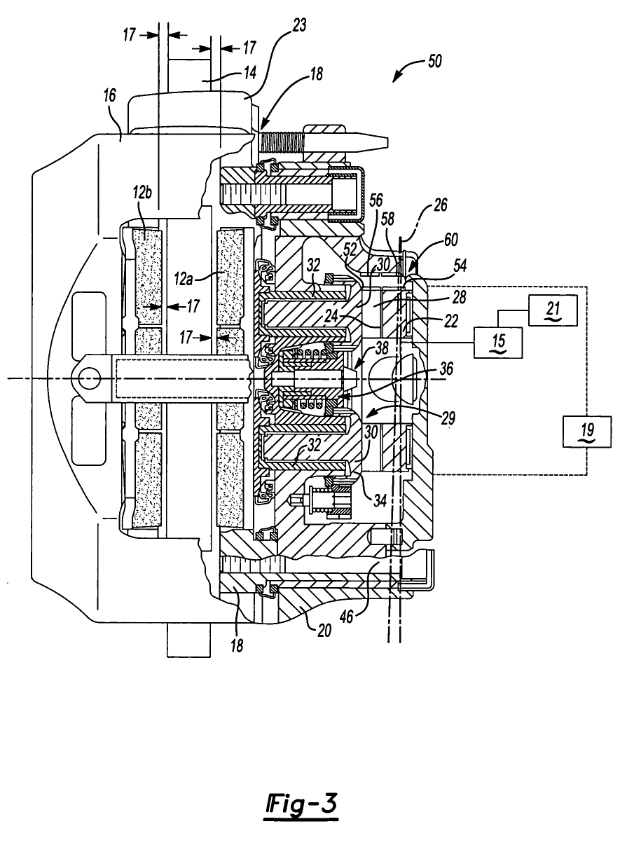

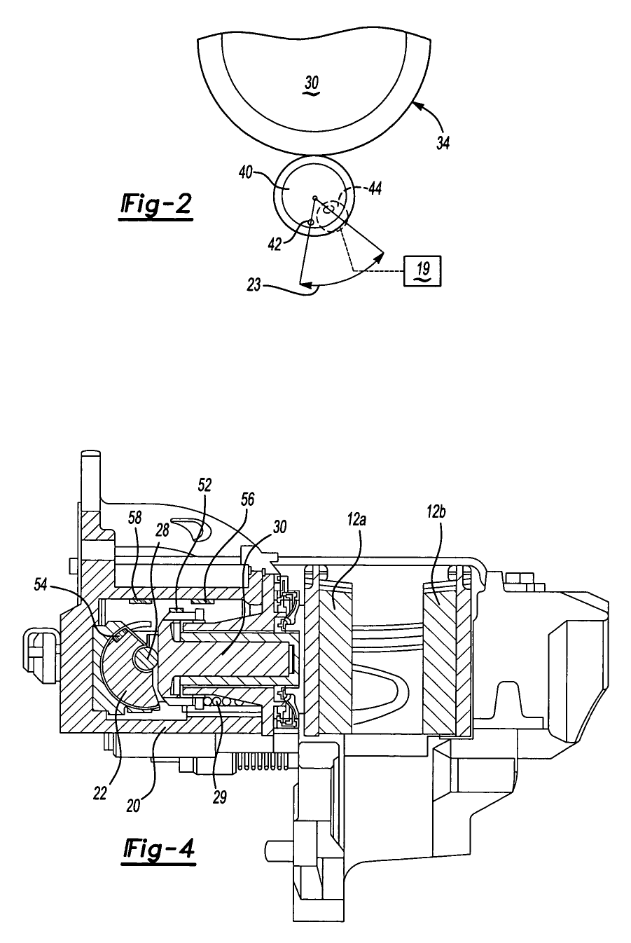

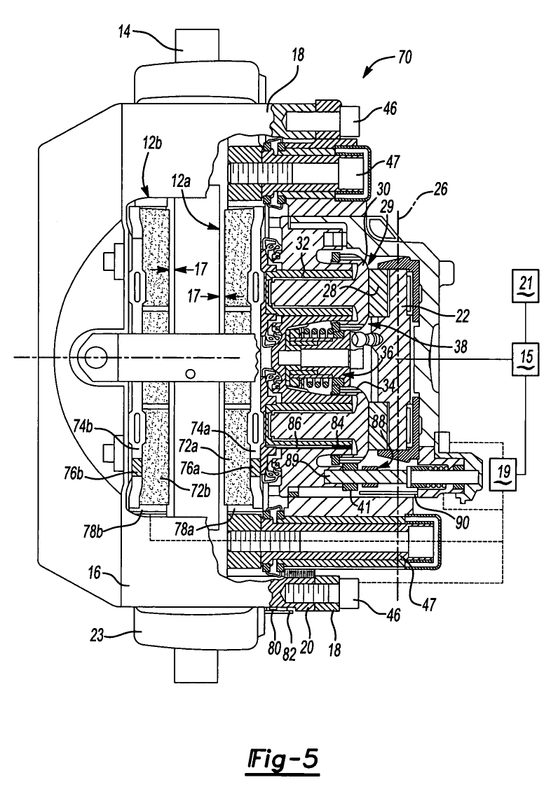

The idler gear 40 is driven by one of the tappet gears 34 and rotates in proportion to rotation of the tappet gears 34. The sensor 42 transmits a signal indicative of an angular position 23 (FIG. 2) of the idler gear 40 in response to a signal generated by the transceiver 44. The controller 19 uses the angular position 43 of the idler gear 40 combined with the known mechanical relationship between rotation of the idler gear 40 and rotation of the tappet gears 34, to derive the length of the tappet assemblies 29. The length, compared with a datum length when the brake pads 12A, 12B are new, provides for a determination of the combined wear of the friction material 72a and 72b (FIG. 5) on each of the brake pads 12A, 12B.

In addition to the angular position of the idler gear 40, the sensor 42 provides speed information. By sampling several different signals from the sensor 42 over a known period, a speed of rotation of the idler gear 40, and thereby the tappet assemblies 29 can be established. The controller 19 receives information indicative of the position of idler gear 40 over a known period and correlates the position and speed of the idler gear 40 with known relationships with the tappet assemblies 29, and the operating shaft 22. The gear ratio between the tappet gear 34 and the idler gear 40, and the speed of the idler gear 40 provide information used to determine the speed of rotation of the tappet assemblies 29.

In addition, knowledge of the thread pitch between the tappet screw 30 and the tappet nut 32, combined with the determined speed of rotation of the tappet screw 30 is used to determine a linear speed of the tappet assemblies 29 during adjustment of the clearance 17. The linear speed of the tappet assemblies 29 is the speed at which the length of the tappet assembly 29 changes.

The brake assembly 10 provides measurement of the clearance 17 between the brake pads 12A, 12B and the rotor 14, along with a measurement of the remaining amount of brake lining on each brake pad 12A, 12B. Once the brake pads 12A, 12B engage the rotor 14; a load is sensed by the load sensor 21 that indicates the engagement. The position of the tappet assembly 29 can be determined to provide a measure of the clearance 17. The tappet assemblies 29 can then be adjusted accordingly.

Additionally, once the load is released, the amount of movement from an engaged position to a released position is measured and is used to provide the measurement of the clearance 17. The load sensor 21 measures a force indicative of the brake pads 12A, 12B abutting the rotor 14. The tappet assembly position when the brake pads 12A, 12B are engaged is compared to the position of the tappet assemblies 29 when the brake pads 12A, 12B are in the released position. The difference between tappet assembly positions in the engaged and released positions provides the clearance 17.

In operation, the actuator 15 rotates the operating shaft 22. The rollers 28 are driven by the operating shaft 22 and move linearly in a direction perpendicular to the axis 26 against the tappet assemblies 29. Linear movement of the tappet assemblies 29 moves the brake pads 12A, 12B into engagement with the rotor 14. The load sensor 21 senses a load on the actuator 15 indicative of contact with the rotor 14. The load sensor 21 configuration is dependent on the actuator 15. For example, an electric actuator may measure current load, while a hydraulic or pneumatic actuator may sense a pressure to determine when contact is made between the brake pads 12A, 12B and the rotor 14. The sensed contact between the rotor 14 and the brake pads 12A, 12B provide a reference point for movement from a home position. The home position is the position of the operating shaft 22 and/or tappet assemblies 29 before movement toward the rotor 14.

Release of the actuator 15 rotates the operating shaft 22 to disengage brake pads 12A, 12B from the rotor 14. Rotational movement of the tappet assemblies 29, rotates the idler gear 40 and thereby the sensor 42, providing a signal indicative of the change in length of the tappet assemblies 29 and angular position 43 of the idler gear 40, relative to the transceiver 44. The rotational displacement of the sensor 42 mounted to the idler gear 40 along with the known mechanical relationship between movement of the idler gear 40 and tappet assemblies 29, provides information indicative of the total distance that the brake pads 12A, 12B have moved from the home position, and thereby the amount of wear of the friction material on each brake pad 12A, 12B.

Knowledge of the amount of clearance 17 provides information to the controller 19 that is used to determine the amount of adjustment necessary in the tappet assemblies 29 to maintain the clearance 17 within desired limits. Once the brake pads 12A, 12B are disengaged from the rotor 14, the electric motor 38 rotates in response to instructions from the controller 19 to drive the tappet screws 30 and adjust the clearance 17. The electric motor 38 preferably moves to adjust the length of the tappet assemblies 29 when the brake pads 12A, 12B are disengaged from the rotor 14. As appreciated, while the brake pads 12A, 12B are disengaged from the rotor 14 the electric motor 38 is not required to overcome the braking force applied to the rotor 14. Adjustment of the tappet assemblies 29 only occurs when the brake pads 12A, 12B are disengaged from the rotor 14, which provides for the use of a smaller, lighter and less power consuming electric motor 38.

Referring to FIG. 3, another brake assembly 50 according to this invention includes a first sensor 52 mounted to one of the rollers 28. The first sensor 52 transmits a position signal including information indicative of tappet screw position in response to a prompt signal received from a first transceiver 56. Alternatively, a second sensor 54 could be mounted on the operating shaft 22 and communicate with a second transceiver 58. The first sensor 52 provides information indicative of a linear position of the tappet assemblies 29. The second sensor 54 provides information indicative of the angular position of the operating shaft 22 that along with known mechanical relationships provides information on the current position of the tappet assembly 29.

The controller 19 communicates with the first and second sensors 52,54 through the first and second transceivers 56, 58 and controls actuation of the electric motor 38. The electric motor 38 provides for the adjustment of the clearance 17.

In operation, the brake pads 12A, 12B engage the rotor 14 in response to actuation of the actuator 15. After engagement, the brake pads 12A, 12B are released and movement of the tappet assemblies 29 and/or the operating shaft 22 away from the rotor 14 is measured. Upon determination that the brake pads 12A, 12B have been disengaged from the rotor 14; the controller 19 determines if an adjustment of the clearance 17 is required. The determination is made with information obtained from the first and second sensors 52, 54 and the known mechanical relationship between the tappet assemblies 29, operating shaft 22 and the brake pads 12A, 12B.

Referring to FIG. 4, the tappet screw 30 and operating shaft 22 are schematically shown with the first sensor 52 disposed on the tappet screw 30 to provide information indicative of linear displacement relative to the inner housing 20 and first transceiver 56.

The second sensor 54, mounted to operating shaft 22, communicates angular displacement information with the second transceiver 58. Angular displacement of the operating shaft 22 combined with knowledge of the known mechanical relationship provides information used by the controller 19 to determine the clearance 17.

Referring to FIG. 5, another brake assembly 70 according to this invention includes wear sensors 76A, 76B on backing plates 74A, 74B to monitor thicknesses of friction material 72A, 72B. The wear sensors 76A, 76B communicate via a wireless transmitted signal by wear transceivers 78A, 78B. The wear transceivers 78A, 78B are mounted to the fixed caliper pad carrier 23 that remains fixed relative to movement of the caliper housing 18 and brake pads 12A, 12B. Displacement of the brake pads 12A, 12B from the rotor 14 is measured by displacement of the wear sensors 76A, 76B.

The wear sensors 76A, 76B communicate a position of the backing plates 74A, 74B to the wear transceivers 78A, 78B. The position of the backing plates 74A, 74B, when engaged to the rotor 14, provides an indication of a thickness of the friction material 72A, 72B. Further, even when not engaged to the rotor 14, the position of the backing plates 74A, 74B, along with known relationships between other brake components and the rotor 14 provides information indicative of displacement of the backing plates 74A, 74B and thereby the thickness of the friction material 72A, 72B. With the brake pads 12A, 12B engaged to the rotor 14, the distance between the backing plates 74A, 74B and the rotor 14 is the same as the remaining thickness of the friction material 72A, 72B. Further, even if not engaged to the rotor 14, the thickness of the friction material 72A, 72B can be determined with information on the position of the brake pad backing plates 74A, 74B. Therefore, the thickness of the friction material 72A, 72B during each engagement of the brake pads 12A, 12B is measured and this information forwarded to the controller 19.

A housing sensor 80 is attached to the inner housing 20 and a housing transceiver 82 is mounted to the caliper housing 18. The caliper housing 18 moves relative to the fixed caliper pad carrier 23 in response to engagement of the brake pad 12A with the rotor 14. The displacement of the caliper housing 18 relative to the fixed pad carrier 23 compared to the relative position between the two with the brake pads 12A, 12B in a new condition provides information indicative of wear on the brake pads 12A, 12B.

The brake assembly 70 also includes a tappet sensor 84 mounted to the tappet nut 32. The tappet sensor 84 communicates displacement of the tappet nut 32 with a tappet transceiver 86 mounted to inner housing 20. The measured displacement between the tappet sensor 84 and the tappet transceiver 86 is indicative of displacement of the tappet nut 32 from an engaged position with the rotor 14, and is forwarded to the controller 19. The displacement of the tappet nut 32 relative to the inner housing 20, combined with known mechanical relationships between the tappet nut 32 and the brake pads 12A, 12B, is used to determine the amount of pad wear.

An idler gear 41 is driven by one of the tappet nuts 32 and includes an idler gear sensor 88 in communication with an idler gear transceiver 90. The idler gear sensor 88 communicates information indicative of angular displacement of the idler gear 41. The idler gear sensor 88 is mounted on a threaded shaft 89. The idler gear sensor 88 moves linearly in response to rotation of the shaft 89. The number of rotations of the shaft 89 relative to linear movement of the idler gear sensor 88 is known. Accordingly, the linear distance traveled by the idler gear sensor 88 corresponds according to the known mechanical relationship between the threaded shaft 89, idler 41 and the tappet nut 32.

Multiple rotations of the idler gear 41, communicated by the idler gear sensor 88 to the idler gear transceiver 90, are used to determine the length of the tappet nut 32. Each rotation of the tappet screw 30 increases the length of the tappet assembly 29 by a known amount. Counting each rotation of the idler gear 41 to communicate angular displacement provides information indicative of the change of length of the tappet assemblies 29 to the controller 19. Counting rotations of the idler gear 41 provides information regarding the change in length of the tappet assemblies 29. The length of the tappet assemblies 29 can then be used to determine wear to the brake pads 12A, 12B.

A brake assembly designed with the advantage of this disclosure provides an accurate and reliable means of determining brake pad thickness and the clearance between a rotor and brake pads without modification to existing brake components. Further, because the sensors are powered by signals from the transceiver and because no additional wiring is required for the sensors, modifications to current brake configurations to include the sensors are minimized.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A brake assembly comprising:
a friction member to be engageable with a rotatable member;
a first sensor mounted relative to a first transceiver, said first sensor sending a position signal indicative of a relative position between said friction member and the rotatable member to said first transceiver in response to said first transceiver sending a prompt signal.

2. The assembly of claim 1, wherein said first sensor comprises an inductive resonance device that transmits information in response to receiving said prompt signal.

3. The assembly of claim 1, including a motor for driving an adjustable member to adjust a clearance between said friction member and the rotatable member.

4. The assembly of claim 3, wherein said first transceiver is mounted to a housing fixed relative to said adjustable member.

5. The assembly of claim 3, wherein said first sensor is mounted to said adjustable member and produces a signal indicative of a current position of said adjustable member.

6. The assembly of claim 3, including an idler gear rotatable in response to movement of said adjustable member, said first sensor mounted for rotation with said idler gear.

7. The assembly of claim 6, wherein said first sensor communicates an angular position of said idler gear to said first transceiver.

8. The assembly of claim 1, including an operating shaft rotatable about an axis for moving said friction member into engagement with the rotatable member, a second sensor mounted for rotation with said operating shaft, and a second transceiver fixed relative to said operating shaft, said second sensor producing a signal indicative of an angular position of said operating shaft to said second transceiver.

9. The assembly of claim 1, wherein said friction member comprises a backing plate and friction material, wherein said first sensor is mounted on said backing plate for communicating information indicative of a position of said backing plate to said first transceiver.

10. The assembly of claim 9, including a movable housing, a fixed housing, and a housing sensor mounted to said movable housing, said housing sensor communicating information indicative of a position of said movable housing to a housing transceiver mounted to said fixed housing.

11. The assembly of claim 1O, wherein said housing sensor communicates information indicative of a relative position between said movable housing and said fixed housing.

12. A method of determining clearance between a friction member and a rotatable member, said method comprising the steps of:
a) communicating a first position signal between a first sensor and a first transceiver indicative of a position of a movable brake component;
b) determining contact between the friction member and the rotatable member in response to a predetermined force measurement; and
c) determining a position of the friction member relative to the rotatable member based on the first position signal, the predetermined force measurement and a known relationship between the movable brake component and the friction member.

13. The method of claim 12, wherein the first sensor is an inductive resonance device and said step a) comprises transmitting the first position signal from the inductive resonance device in response to a prompt signal transmitted by the first transceiver.

14. The method of claim 13, further comprising the step of transmitting a second position signal from a second sensor indicative of a position of an adjustable member.

15. The method of claim 14, comprising the step of determining a relative displacement between the adjustable member and the movable brake component based on the first and second position signals.

16. The method of claim 12, wherein said step a) comprises communicating an angular displacement of the movable brake component.

17. The method of claim 16, including determining a speed of an adjustable member based on the first position signal from the first sensor.

18. A method of determining a thickness of friction material of a brake pad, said method comprising the steps of:
a) sensing engagement of the friction material with a rotatable brake member;
b) communicating a first position between a first sensor and a first transceiver indicative of a position of a backing plate supporting the friction material relative to the rotatable brake member; and
c) determining a thickness of the friction material based on the first position signal during engagement with the rotatable brake member.

19. The method of claim 18, wherein the first sensor is an inductive resonance device and said step b) comprises transmitting the first signal in response to a signal transmitted by the first transceiver.

20. The method of claim 19, wherein the first transceiver is mounted to a component fixed relative to the rotatable brake member, and said step c) comprises determining a thickness of the friction material utilizing a known mechanical relationship between the rotatable brake member and the backing plate.
